(19) United States
(12) Patent Application Publication
(10) Pub. No.: US 2026/0117768 A1
(43) Pub. Date: Apr. 30, 2026

(54) INTERVENING REINFORCEMENT LINING FOR A MUD MOTOR

(71) Applicant: Schlumberger Technology Corporation, Sugar Land, TX (US)

(72) Inventors: Qingxiu LI, Katy, TX (US); Anton KOLYSHKIN, Nisku (CA); Eric JOHNSON, Sugar Land, TX (US); Li GUO, Houston, TX (US)

(21) Appl. No.: 19/143,403

(22) PCT Filed: Dec. 20, 2023
(86) PCT No.: PCT/US2023/085191

§ 371 Date: Jun. 26, 2025

Related U.S. Application Data
(60) Provisional application No. 63/478,255, filed on Jan. 3, 2023.

(51) Int. Cl. F04C 2/107; B32B 5/02; B32B 15/06; B32B 25/10; E21B 4/02

(52) U.S. Cl. CPC F04C 2/107; B32B 5/024; B32B 15/06; B32B 25/10; B32B 2250/04; E21B 4/02; F04C 2240/30

(57) ABSTRACT

Systems and methods presented herein relate to forming a composite reinforcement lining. A system includes a compression molded elastomer reinforcement composite having a first layer, a second layer, and an intervening layer disposed between the first layer and the second layer. The first layer includes one or more first elastomer materials. The second layer includes one or more second elastomer materials. The intervening layer includes one or more composite reinforcement materials having a hardness greater than the one or more first elastomer materials and the one or more second elastomer materials.

### BACKGROUND

This application claims the benefit of U.S. Provisional Application No. 63/478,255, entitled “INTERVENING REINFORCEMENT LINING FOR A MUD MOTOR,” filed Jan. 3, 2023, the disclosure of which is hereby incorporated herein by reference.

### BACKGROUND

The present disclosure generally relates to downhole tools for drilling operations. More specifically, the present disclosure relates to techniques for providing an abrasion resistant layer on components of the downhole tools.

This section is intended to introduce the reader to various aspects of art that may be related to various aspects of the present techniques, which are described and/or claimed below. This discussion is believed to be helpful in providing the reader with background information to facilitate a better understanding of the various aspects of the present disclosure. Accordingly, it should be understood that these statements are to be read in this light, and not as an admission of any kind.

A variety of drilling equipment may be subject to mechanical abrasion during operation. For example, a mud motor (e.g., a drilling motor), and components of the mud motor, such as the stator, an elastomer lining on the stator, and a rotor, may be subject to mechanical loads from the rotor of the drilling motor and mud pressure. As the drilling environment becomes increasingly more challenging (e.g., mud motors operating for longer durations and/or drilling through harder geological formations), the mud motor may experience further mechanical abrasion. Accordingly, it may be difficult for the mud motor to operate while providing higher power output with better reliability under more demanding conditions.

### SUMMARY

A summary of certain embodiments described herein is set forth below. It should be understood that these aspects are presented merely to provide the reader with a brief summary of these certain embodiments and that these aspects are not intended to limit the scope of this disclosure.

A method includes providing a first layer of an elastomer material, providing an intervening layer onto the first layer, forming a preforming using the first layer and the intervening layer, and compression molding the preform to form a composite reinforcement lining. The intervening layer includes one or more materials having a hardness greater than the elastomer material.

A system includes a stator housing of a mud motor and a composite elastomer lining. The composite elastomer lining includes a first elastomer layer coupled to an inner surface of the stator housing, a second elastomer layer configured to receive a rotor of the mud motor, and an intervening layer disposed between the first elastomer layer and the second elastomer layer. The intervening layer includes a plurality of reinforcement fibers.

A system includes a compression molded elastomer reinforcement composite having a first layer, a second layer, and an intervening layer disposed between the first layer and the second layer. The first layer includes one or more first elastomer materials. The second layer includes one or more second elastomer materials. The intervening layer includes one or more composite reinforcement materials having a hardness greater than the one or more first elastomer materials and the one or more second elastomer materials.

Certain embodiments of the present disclosure include a system. The system includes a compression molded elastomer reinforcement composite including a first layer including one or more first elastomer materials. The compression molded elastomer reinforcement composite also includes a second layer comprising one or more second elastomer materials. Further, the compression molded elastomer reinforcement composite includes an intervening layer disposed there between the first layer and the second layer. The intervening layer includes one or more reinforcement materials having a hardness greater than the one or more first elastomer materials and the one or more second elastomer materials.

Various refinements of the features noted above may be undertaken in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings, in which:

FIG. 1 shows a schematic view of a downhole motor assembly, in accordance with embodiments of the present disclosure;

FIG. 2 shows a cross sectional perspective view of a power section of a downhole motor tool of the downhole motor assembly of FIG. 1 along a longitudinal axis of the downhole motor tool, in accordance with embodiments of the present disclosure;

FIG. 3 shows a cross-sectional perspective view of a power section of the downhole motor tool of FIG. 2 along a transverse axis of the downhole motor tool, in accordance with embodiments of the present disclosure;

FIG. 4 is a block diagram of a downhole motor, in accordance with embodiments of the present disclosure;

FIG. 5 is a cross-sectional perspective view of a power section of a mud motor, in accordance with embodiments of the present disclosure;

FIG. 6 is a cross-sectional perspective of a portion of the power section of the stator, in accordance with embodiments of the present disclosure;

FIG. 7 is a schematic diagram of a reinforcement fiber, in accordance with embodiments of the present disclosure;

FIG. 8 is a perspective view of a stator of a downhole motor having an example of an anisotropic elastomer reinforcement lining, in accordance with embodiments of the present disclosure;

FIG. 9 is a flow diagram illustrating a process for applying an anisotropic elastomer reinforcement lining, in accordance with embodiments of the present disclosure;

FIGS. 10A and 10B are cross-sectional perspective views of a stator at different times during a manufacturing, in accordance with embodiments of the present disclosure;

FIG. 11 is a schematic diagram of an injection molding system, in accordance with embodiments of the present disclosure;

FIG. 12 is a perspective view of an anisotropic elastomer reinforcement lining wound around a mandrel, in accordance with embodiments of the present disclosure;

FIG. 13 is a cross-sectional perspective view of a stator a downhole motor having a first example of a composite reinforcement lining, in accordance with embodiments of the present disclosure;

FIG. 14 is a cross-sectional perspective view of a stator a downhole motor having a second example of a composite reinforcement lining, in accordance with embodiments of the present disclosure; and

FIG. 15 is a flow diagram illustrating a process for forming and applying a composite reinforcement lining, in accordance with embodiments of the present disclosure.

### DETAILED DESCRIPTION

One or more specific embodiments of the present disclosure will be described herein. These described embodiments are only examples of the presently disclosed techniques. Additionally, in an effort to provide a concise description of these embodiments, all features of an actual implementation may not be described in the specification. It should be appreciated that in the development of any such actual implementation, as in any engineering or design project, numerous implementation-specific decisions must be made to achieve the developers'specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

As used herein, the terms “connect,” “connection,” “connected,” “in connection with,” and “connecting” are used to mean “in direct connection with” or “in connection with via one or more elements”; and the term “set” is used to mean “one element” or “more than one element.” Further, the terms “couple,” “coupling,” “coupled,” “coupled together,” and “coupled with” are used to mean “directly coupled together” or “coupled together via one or more elements.” As used herein, the terms “up” and “down,” “uphole” and “downhole”, “upper” and “lower,” “top” and “bottom,” “above” and “below,” and other like terms indicating relative positions to a given point or element are utilized to more clearly describe some elements. Commonly, these terms relate to a reference point as the surface from which drilling operations are initiated as being the top (e.g., uphole or upper) point and the total depth along the drilling axis being the lowest (e.g., downhole or lower) point, whether the well (e.g., wellbore, borehole) is vertical, horizontal or slanted relative to the surface.

In the present context, the term “about” or “approximately” is intended to mean that the values indicated are not exact and the actual value may vary from those indicated in a manner that does not materially alter the operation concerned. For example, the term “about” or “approximately” as used herein is intended to convey a suitable value that is within a particular tolerance (e.g., ±10%, ±5%, ±1%, ±0.5%), as would be understood by one skilled in the art.

As mentioned above, components of a mud motor may be subject to downhole conditions that result in mechanical deterioration of the components of the mud motor. In general, a mud motor converts pressure energy from the drilling fluid through the mud motor to rotational energy for application to drilling tools along the drill string, such as a drill bit or reamer. A mud motor includes a rotor that rotates within a stator to generate the power that spins a drill bit. Loads on the drill bit, rotor, and stator cause stresses on the mud motor components. The magnitude of the loads, the duration of the loads, and downhole conditions (e.g., temperature, mud composition, pressure) affect the lifetime of the mud motor components. Anisotropic reinforcement of the elastomer lining of a mud motor against certain loads are believed to increase the effective lifetime of the mud motor.

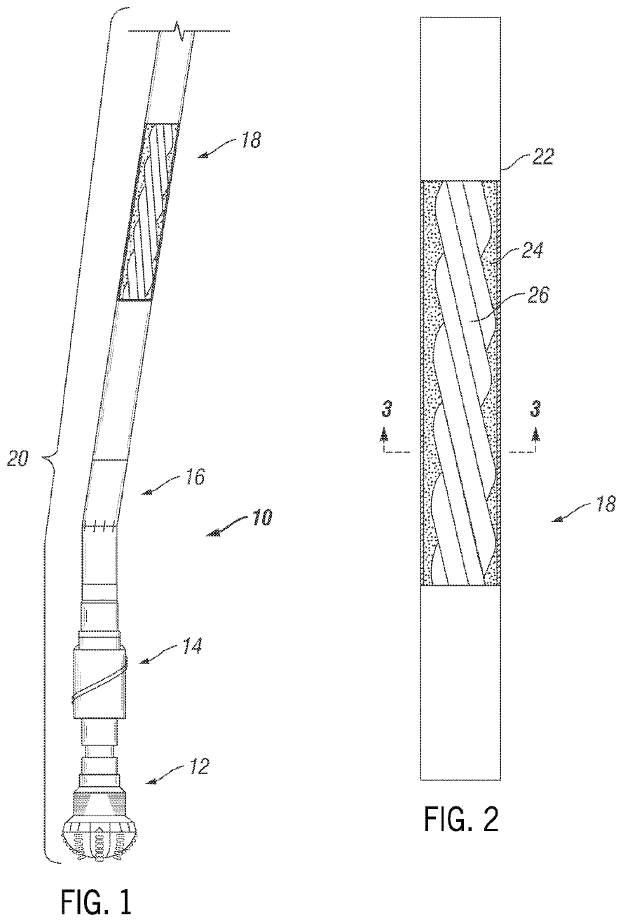

With this in mind, FIG. 1 shows a conventional downhole motor assembly. The motor assembly 10 generally includes a rotatable drill bit 12, a bearing/stabilizer section 14, a transmission section 16 which may include an adjustable bent housing, and a motor power section 18. The bent housing 16 is not an essential part of the motor assembly, and is only used in directional drilling applications. During operation, drilling fluid pumped through the drill string 20 from the drilling rig at the earth's surface passes through the motor power section 18 and exits the assembly 10 through the drill bit 12.

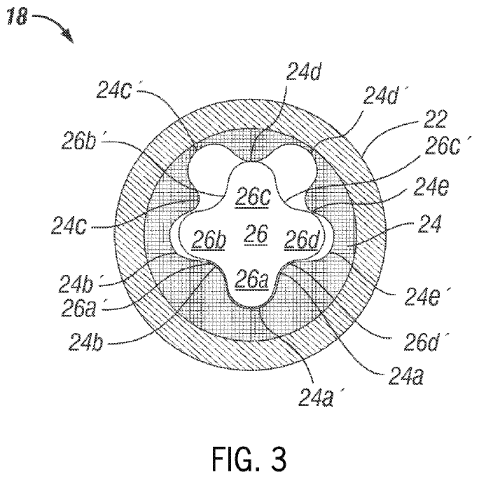

FIGS. 2 and 3 show details of the power section 18 of a conventional downhole motor. The power section 18 generally includes a tubular housing 22 which houses a motor stator 24 within which a motor rotor 26 is rotationally mounted. The power section 18 converts hydraulic energy into rotational energy by reverse application of the Moineau pump principle. It will be appreciated by those skilled in the art that the difference between a “motor” and a “pump” as used herein is the direction of energy flow. Thus, a progressive cavity motor may be operated as a progressive cavity pump by direct (as opposed to reverse) application of the Moineau pump principle wherein rotational energy is converted into hydraulic energy. For the sake of clarity, the term “motor” will be used hereafter to mean a device that transforms energy between hydraulic energy and rotational energy, typically (but not exclusively) in the direction of a hydraulic-to-rotational energy transformation.

The stator 24 has a plurality of helical lobes, 24a-24e (i.e., 24a, 24b, 24c, 24d, and 24e), which define a corresponding number of helical cavities, 24a′-24e′ (i.e., 24a′, 24b′, 24c′, 24d′, and 24e′). The rotor 26 has a plurality of lobes, 26a-26d (i.e., 26a, 26b, 26c, and 26d), which number one fewer than the number of stator lobes and which define a corresponding plurality of helical cavities 26a′-26d′ (i.e., 26a', 26b′, 26c′, and 26d′). Generally, the greater the number of lobes on the rotor and stator, the greater the torque generated by the motor power section 18. Fewer lobes will generate less torque but will permit the rotor 26 to rotate at a higher speed. The torque output by the motor is also dependent on the number of “stages” of the motor, a “stage” being one complete spiral of the stator helix.

In conventional downhole motors, the stator 24 primarily consists of an elastomeric lining that provides the lobe structure of the stator. The stator lining is typically injection-molded into the bore of the housing 22, which limits the choice of elastomeric materials that may be used. During refurbishment, the stator must be shipped to a place where the injection molding can be performed. This increases the costs of maintenance of the motors.

The rotor is typically made of a suitable steel alloy (e.g., a chrome-plated stainless steel) and is dimensioned to form a tight fit (i.e., very small gaps or positive interference) under expected operating conditions, as shown in FIG. 3. It is generally accepted that either or both the rotor and stator must be made compliant in order to form suitable hydraulic seals. The rotor 26 and stator 24 thereby form continuous seals along their matching contact points which define a number of progressive helical cavities. When drilling fluid (mud) is forced through these cavities, it causes the rotor 26 to rotate relative to the stator 24.

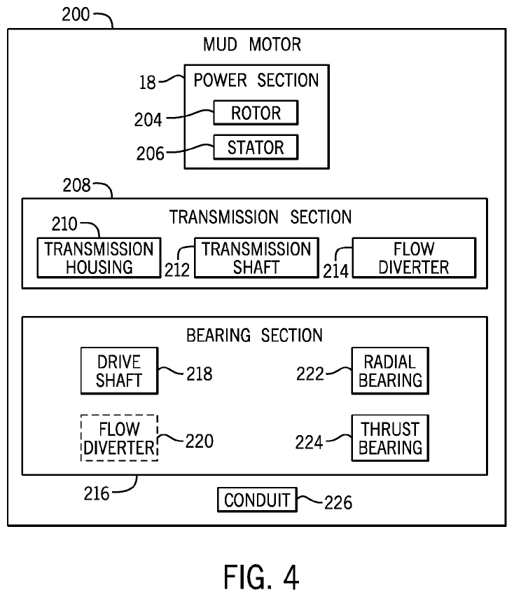

FIG. 4 is a block diagram of a downhole (e.g., mud) motor 200. As illustrated, in certain embodiments, the downhole motor 200 includes a power section 18 that converts hydraulic energy of the drilling fluid into mechanical rotary energy, a transmission section 208 that transfers the mechanical rotary energy generated by the power section 18 to a drive shaft, and a bearing section 216 that supports axial and radial loads of the drive shaft during drilling as it transfers the mechanical rotary energy generated by the power section 18 to a downhole tool.

The power section 18 of the downhole motor 200 may include a helical rotor 204 rotatably disposed within the longitudinal bore of a helical stator 206. The downhole motor 200 may be fabricated in a variety of configurations. Generally, when viewed cross-sectionally, the rotor 204 has Nᵣ lobes and the stator 206 has Nₛ lobes, wherein Nₛ=Nᵣ+1. In operation, the helical formation on the rotor 204 seals tightly against the helical formation of the stator 206 as the rotor 204 rotates to form a set of cavities between respective lobes of the stator 206 and the rotor 204. The drilling fluid flows in the cavities. The hydraulic pressure of the drilling fluid causes the cavities to progress axially along the longitudinal axis of the power section, and causes a relative rotation between the rotor 204 and the stator 206 about the longitudinal axis.

In certain embodiments, the transmission section 208 of the downhole motor 200 includes a transmission housing 210 that encloses and houses a transmission shaft 212. The transmission shaft 212 may have a hollow central passage through which the drilling fluid may flow. The transmission shaft 212 is connected to or integral with the rotating rotor 204 of the power section 18. The transmission shaft 212 is connected to or integral with the drive shaft 218 of the bearing section 216. The transmission shaft 212 conveys the rotary energy generated by the power section 18 to the drive shaft 218 of the bearing section 216. In certain embodiments, a flow diverter 214 may be provided in the transmission section 208 (e.g., disposed or formed in the transmission shaft 212) to divert the flow of the drilling fluid from an axial flow through the hollow central passage of the transmission section 208 to a radial flow.

In certain embodiments, the bearing section 216 of the downhole motor 200 includes a drive shaft 218 that includes a hollow central passage through which the drilling fluid may flow. The drive shaft 218 transfers the mechanical rotary energy transmitted by the transmission section 208 to one or more downhole tools (e.g., a drill bit 105). The bearing section 216 includes a set of radial bearings 222 that supports radial loads during drilling and a set of thrust bearings 224 that supports axial loads during drilling. In certain embodiments, a flow diverter 220 may be provided in the bearing section 216 (e.g., disposed or formed in the drive shaft 218) to divert the flow of the drilling fluid from an axial flow through the hollow central passage of the transmission section 208 to a radial flow.

The stator of the mud motor may be a stator housing lined with an elastomer lining, layer, or coating that improves the wear and abrasion resistance of the stator. During operation, the elastomer surface (i.e., the surface of the elastomer lining, layer, or coating) is subjected to mechanical loads by a rotor of the mud motor and/or abrasion due to drilling fluids and high temperatures downhole. The loads and/or abrasion of the stator lining may cause deformation of the stator lining. Loads beyond a threshold of the elastomer lining may plastically deform or crack loaded portions of the elastomer lining. Additionally, or in the alternative, cyclic loading at or beyond a lower threshold may fatigue the elastomer lining, thereby plastically deforming or cracking loaded portions of the elastomer lining. Plastic deformation or cracks of the elastomer lining may result in premature failure of the elastomer lining. For example, fatigue chunking generally includes a process of crack nucleation at the elastomer surface, growth or propagation of a crack along a crack plane from the crack nucleation and, ultimately, elastomer disintegration and failure, impacting motor efficiency up to inability to continue drilling. As referred to herein, the “crack plane” is generally a plane where crack propagates. When cracks propagate, a material (e.g., an elastomer) is split, thereby forming two surfaces on either side of the crack plane. For simplicity, a crack tip line can be approximated as a straight line locally (i.e., at a circumferential and helical position along the stator). Thus the straight line corresponding to local translation of the crack tip line forms a plane. The translation vector is a crack propagation direction. In general, the crack tip line and crack propagation direction are different directions on the crack plane.

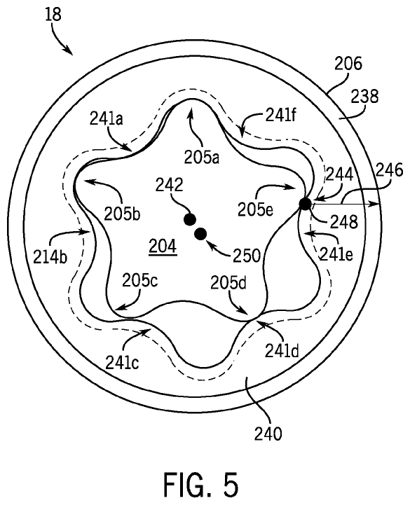

To improve the longevity of the stator, it is presently recognized that it may be advantageous to line, coat, or otherwise cover an inner surface of the stator housing with an anisotropic elastomer reinforcement lining having reinforcement fibers that are oriented substantially perpendicular to a helical direction of a helical surface of a stator, as described in more detail with respect to FIG. 5. As referred to herein, the “helical direction” is a tangent line to a helical line formed as a set of points at a stator surface that are equidistant from the stator axis. In general, a crack may propagate along the helical direction on the elastomer surface. As such, it may be advantageous to orient the reinforcement fibers to be substantially perpendicular with the helical direction, and thus, perpendicular to the crack propagation direction, to reduce, prevent, or block the crack from propagating further, thereby improving the longevity of the stator.

Accordingly, the present disclosure generally relates to techniques for producing an anisotropic elastomer reinforcement lining having reinforcement fibers to improve the longevity and mechanical abrasion resistance of a stator using injection molding or compression molding techniques. In general, the reinforcement fibers have a length that is greater than other dimensions. For example, the length of the fiber may be 1, 2, or 3 orders of magnitude greater than any other dimension of the fiber. The orientation of the reinforcement fibers may be defined by a vector between two ends of the reinforcement fiber along the major axis (e.g., a longitudinal axis), as discussed in more detail with respect to FIG. 7. As will be discussed in greater detail below, a dominant orientation of the reinforcement fibers within the anisotropic elastomer reinforcement lining is such that a major axis (i.e., the axis along the longest dimension of the reinforcement fibers) of a population or percentage of the reinforcement fibers is substantially perpendicular with the helical direction of the stator (e.g., as described in more detail with respect to FIG. 5). As referred to herein, an orientation of one or more reinforcement fiber that are “substantially parallel” to a different axis (e.g., corresponding to a surface of a stator) refers to the orientation of the reinforcement fiber being within an angular offset range of the particular axis (e.g., between −45°and 45°, between −35°and 35°, between −25°and 25°, or between −15°and 15°).

As described in more detail herein, a material composite including reinforcement fibers and an elastomer may be applied to a mandrel within a housing. In general, the material composite may be mechanically worked (e.g., stretched and/or pressed by one or more mandrels), thereby causing at least a portion of the reinforcement fibers to orient in a direction such that the dominant orientation of the reinforcement fibers is substantially perpendicular to the helical direction (e.g., a local helical direction). The dominant orientation of the reinforcement fibers of the anisotropic elastomer reinforcement lining may be an orientation shared by 50% or greater of the reinforcement fibers, 60% or greater of the reinforcement fibers, or 70% or greater of the reinforcement fibers. The material composite with the at least partially aligned reinforcement fibers is referred to herein as an anisotropic material composite. The anisotropic material composite may be cured (e.g., via heat), thereby forming the anisotropic elastomer reinforcement lining having reinforcement fibers distributed in its volume and oriented in certain direction.

The anisotropic elastomer reinforcement lining described herein may be deposited onto a substrate, such as an elastomer surface of a stator or a stator housing of a drilling motor, to improve the longevity and abrasion resistance of the stator. Moreover, the anisotropic elastomer reinforcement lining may have improved longevity and abrasion resistance than conventional elastomer layers applied to or disposed on stators. By producing an anisotropic elastomer reinforcement lining with the dominant orientation of the reinforcement fibers being substantially perpendicular to the helical direction of the lobes (i.e., perpendicular to a crack plane that may form), the anisotropic elastomer reinforcement lining has more resistance to fatigue chunking, higher hardness, and toughness. In certain embodiments, the deposition process generally includes compression molding or injection molding techniques.

As described herein, the stator 206 and/or the rotor 204 of the power section 18 may include an elastomer reinforcement lining (e.g., elastomer reinforcement coating). To illustrate this, FIG. 5 is a cross-sectional perspective view of an embodiment of the power section 18 of a mud motor 200 that includes a rotor 204 and a stator 206, as described herein. As illustrated, the stator 206 includes a stator housing 238 that is lined with an anisotropic elastomer reinforcement lining 240 having multiple lobes 241 (e.g., 241a, 241b, 241c, 241d, 241e, and 241f) that extend along the stator axis 250 (e.g., stator longitudinal axis). The anisotropic elastomer reinforcement lining 240 may be or include an elastomer material, such as rubber, certain synthetic polymers, and the like. As described herein, in operation, the outer helical surface of the rotor 204 seals tightly against the helical surface of the stator 206 as the rotor 204 turns (e.g., about the rotor longitudinal axis 242) to form a set of helical cavities. In particular, the rotor 204 may seal tightly at a location where a rotor lobe 205 (e.g., 205a, 205b, 205c, 205d, or 205e) contacts the anisotropic elastomer reinforcement lining 240 of the stator 206 between two stator lobes 241, such as a contact location 244 (e.g., a stress point) where the rotor lobe 205A is between the two stator lobes 241e and 241f. At the contact location 244, elastomer deformation caused by the rotor 204 may cause a crack nucleation and propagation and, ultimately, a crack may propagate substantially along a crack direction 246. The crack direction 246 is normal to a helical direction 248 and generally outward toward the stator housing 238. The crack plane formed by the crack nucleation may be defined by the crack direction 246 and the local helical direction 248 (e.g., going into the page at steep angle) at the crack nucleation. It has been recognized that it may be advantageous to line the stator housing 238 with an anisotropic elastomer reinforcement lining 240 that includes reinforcement fibers that have a dominant orientation that is substantially perpendicular to the helical direction of the stator.

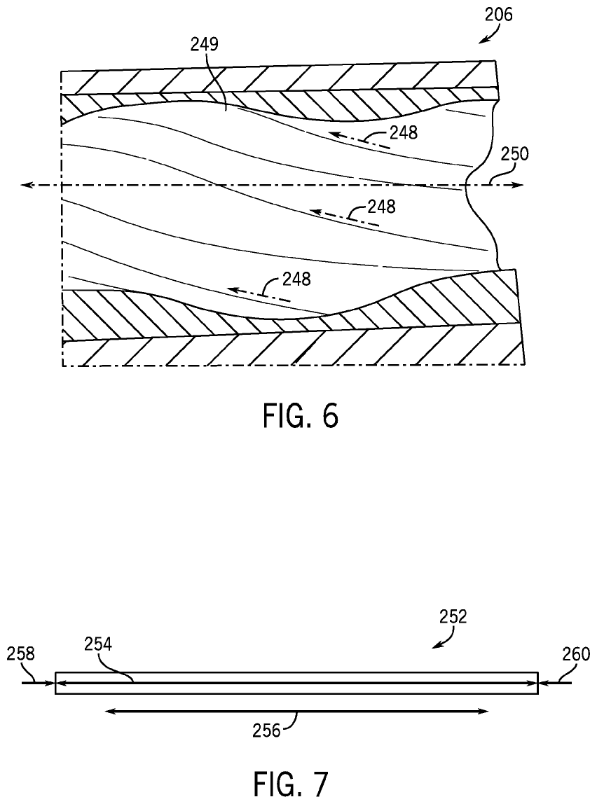

As described above, the anisotropic elastomer reinforcement lining 240 may include reinforcement fibers that are oriented perpendicular to the local helical direction 248 of the stator 206. FIG. 6 is a cross-sectional perspective view of an inner surface of a stator 206 along the stator axis 250. As illustrated, the stator 206 includes a helical surface 249 that generally rotates or winds about the stator axis 250. As such, the local helical direction 248 at points along the helical surface 249 may vary with the position along the stator axis 250 and the circumferential position around the stator axis 250. The local helical direction 248 is the same for points on the helical surface 249 at the same circumferential position and offset by the pitch along the stator axis 250. It is presently recognized that a crack may propagate in the helical direction 248 and the crack direction 246 along the crack plane. Accordingly, to reduce, prevent, or block the crack from propagating such that the stator 206 may fail, it may be advantageous to provide reinforcement fibers having a dominant orientation that is substantially perpendicular to the local helical direction 248. A dominant orientation of the reinforcement fibers of the anisotropic elastomer reinforcement lining 240 may be an orientation shared by 50% or greater of the reinforcement fibers, 60% or greater of the reinforcement fibers, or 70% or greater of the reinforcement fibers.

FIG. 7 shows a block diagram of a reinforcement fiber 252. In the illustrated embodiment, the reinforcement fiber 252 is a multi-dimensional fiber. That is, the reinforcement fiber 252 includes a major dimension 254 (i.e., a length) that corresponds to the axis along the longest dimension of the reinforcement fiber 252. In general, the major dimension 254 of the reinforcement fiber 252 may be two, three, four, or more than four orders of magnitude greater than any other dimension of the reinforcement fiber 252.

The reinforcement fibers 252 have an orientation 256 within the anisotropic elastomer reinforcement lining 240. As referred to herein, the “orientation” of the reinforcement fiber 252 generally corresponds to a vector between two ends of the reinforcement fiber 252, such as the first end 258 and the second end 260. As referred to herein, a dominant orientation of reinforcement fibers 252 refers to a population of the reinforcement fibers 252 (e.g., 50% or more, 60% or more, 70% or more, and so on) having an orientation 256 in a particular direction. For example, as described herein, a reinforcement fiber that is “substantially parallel” to an axis refers to reinforcement fibers having an orientation 256 that is within an offset range of the axis (e.g., between −45° and 45°, between −35° and 35°, between −25° and 25°, or between −15°and 15°). Accordingly, a population of reinforcement fibers having a dominant orientation that is substantially parallel to an axis refers to the population of reinforcement fibers having their orientation 256 being substantially parallel to the axis.

In certain embodiments, the reinforcement fibers 252 may include microfibers (e.g., having a diameter of the microfibers between 1 μm and 500 μm, between 20 μm and 400 μm, between 100 μm and 250 μm, and other suitable dimensions), nanofibers (e.g., having a diameter of the microfibers between 1 nm and 500 nm, between 20 nm and 500 nm, between 100 nm and 400 nm, and other suitable dimensions). In certain embodiments, the reinforcement fibers 252 may include polymer fibers (e.g., nylon fibers), metallic fibers, or non-metallic fibers (e.g., carbon fibers or glass fibers). In certain embodiments, the reinforcement fibers 252 may include relatively large molecules (e.g., polymer chains).

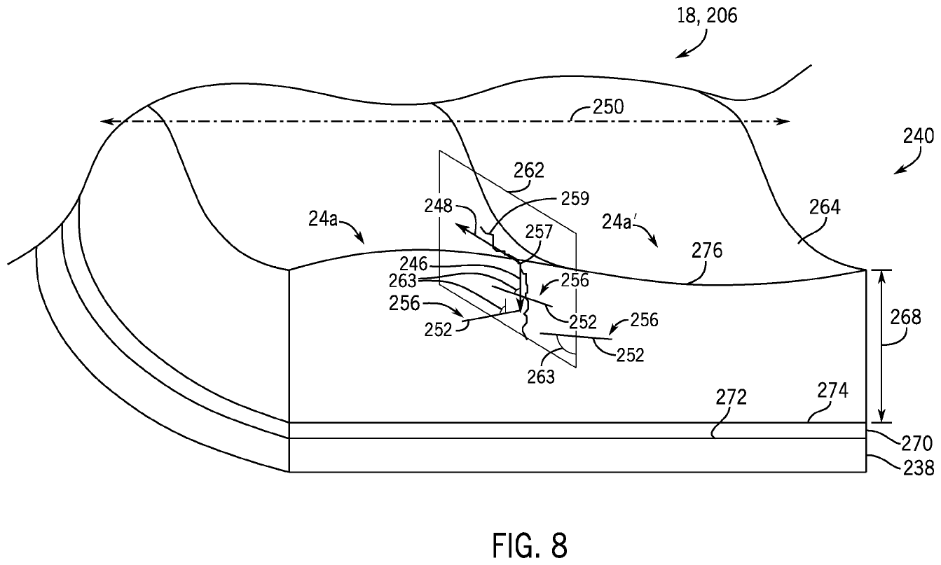

As described herein, it may be advantageous to orient an axis (e.g., a major axis, a longitudinal axis) of a reinforcement fiber 252 such that the orientation of the reinforcement fibers is perpendicular to a direction where a crack may propagate (e.g., perpendicular to a local helical direction 248). To illustrate this, FIG. 8 is a perspective cross-sectional view of a portion of the power section 18 including an anisotropic elastomer reinforcement lining 240 having reinforcement fibers 252 near a crack nucleation site 257. It is appreciated that the three fibers 252 shown in FIG. 8 are for clarity of illustration and that the anisotropic elastomer reinforcement lining of a mud motor may have more fibers distributed throughout. As illustrated, the reinforcement fibers 252 are dispersed along the thickness 268 of the anisotropic elastomer reinforcement lining 240. In some embodiments, the thickness 268 may be between 1 cm and 20 cm, 5 cm and 15 cm, 8 and 12 cm. In some embodiments, the thickness 268 of the anisotropic elastomer reinforcement lining 240 varies along the stator axis 250 and with the circumferential position of the stator 206 because of the helical stator lobes (e.g., lobe 24a) and lobe cavities (e.g., lobe cavity 24a′) described above.

The dominant orientation of the reinforcement fibers 252 may be substantially perpendicular to the local helical direction 248 at the crack nucleation site 257. As discussed above, the local helical direction 248 corresponds to a direction along the interior stator surface 276 in which a crack 259 may propagate. Additionally, the crack direction 246 corresponds to a direction perpendicular to the local helical direction at the crack nucleation site 257. Together, the local helical direction 248 and the crack direction 246 form the crack plane 262 at the crack nucleation site 257. As such, the reinforcement fibers 252 oriented to be substantially perpendicular to the crack plane 262 may reduce, prevent, or block the crack 259 from propagating further, thereby improving the longevity of the stator. Further, the fiber orientations 256 have angular offsets 263 with the crack plane 262. In certain embodiments, an angular offset 263 between the crack plane 262 and the fiber orientation 256 may be between −45° to 45°. In certain embodiments, the angular offset 263 may be between −35° to 35°, −25° to 25°, −15° to 15°, or −5° to 5°.

As illustrated, in certain embodiments, the anisotropic elastomer reinforcement lining 240 may be coupled to the stator housing 238 via an adhesion layer 270. More specifically, the adhesion layer 270 may be coupled to an inner surface 272 of the stator housing 238 and an outer surface 274 of the anisotropic elastomer reinforcement lining 240. In general, the adhesion layer 270 may improve the coupling (e.g., adhesive coupling) between the stator housing 238 and the anisotropic elastomer reinforcement lining 240. Furthermore, the adhesion layer 270 may fill any gaps that may otherwise form between the stator housing 238 and the anisotropic elastomer reinforcement lining 240. However, in other embodiments, the adhesion layer 270 may be omitted.

Although only three reinforcement fibers 252 are shown in the anisotropic elastomer reinforcement lining 240 in FIG. 8, it should be noted that the anisotropic elastomer reinforcement lining 240 may include any number of reinforcement fibers 252, any suitable density, or any suitable volume percentage (%) of reinforcement fibers 252 within the elastomer material 264. For example, an elastomer material 264 may include 1%, 2%, 5%, 10%, 15%, 20%, or greater than 20% by volume of reinforcement fibers 252. At least in some instances, the density or volume percentage of the reinforcement fibers 252 may vary at different depths. For example, it may be advantageous to include a higher density of volume of reinforcement fibers 252 at a depth where a crack is more likely to occur, such as within a threshold distance from the interior surface 276 of the anisotropic elastomer reinforcement lining 240. In some embodiments, the threshold distance may be 10%, 25%, or 50% of the thickness 268. In some embodiments, the threshold distance is an absolute distance like the dashed outline illustrated in FIG. 5, such as approximately 5 mm, 10 mm, 20 mm, 40 mm, or 50 mm. The volume percentage of the reinforcement fibers 252 within the anisotropic elastomer reinforcement lining may be relatively higher within the threshold distance from the interior surface 276, or the volume percentage may increase from the outer surface 274 towards the interior surface 276. Put differently, a first location corresponding to a first depth range (e.g., 10% of thickness 268) from the interior surface 276 within the anisotropic elastomer reinforcement lining 240 may include relatively more reinforcement fibers 252 than a second location corresponding to a second depth range (e.g., 75% of thickness 268) from the interior surface 276.

At least in some instances, providing multiple layers having reinforcement fibers 252 that are substantially oriented perpendicular to an adjacent layer may improve the strength, toughness, and fatigue resistance of the anisotropic elastomer reinforcement lining 240. For example, the anisotropic elastomer reinforcement lining 240 may include one or more layers coupled to the stator housing 238 (e.g., via an adhesion layer 270) having reinforcement fibers 252 that are oriented in a first direction (e.g., substantially parallel to the stator axis 250). The anisotropic elastomer reinforcement lining 240 may include one or more additional layers that are oriented in a second direction (e.g., substantially perpendicular to the local helical direction 248).

In some embodiments, different portions, layers, or locations within the anisotropic elastomer reinforcement lining 240 may have different orientations. At least in some instances, it may be advantageous to have reinforcement fibers within a particular layer or distance from the helical surface 249 of the stator 206 to be perpendicular to the helical direction. For example, a first layer of the anisotropic elastomer reinforcement lining 240 may be substantially parallel to a first axis, while a second layer of the anisotropic elastomer reinforcement lining 240 may be substantially parallel to a second axis that is different than the first axis (e.g., the second axis is perpendicular to the first axis). At least in some instances, a degree of alignment of the reinforcement fibers 252 may vary based on a location (e.g., depth, axial position, placement within stator lobe or lobe cavity) of the reinforcement fibers 252 within the anisotropic elastomer reinforcement lining 240. That is, a first portion of the anisotropic elastomer reinforcement lining 240 may include a first distribution (e.g., greater than 50%, or greater than 60%) of reinforcement fibers 252 that are substantially perpendicular to the stator local helical direction 248. A second portion of the anisotropic elastomer reinforcement lining 240 may include a second distribution of reinforcement fibers 252 that are substantially parallel to the stator local helical direction 248. For example, in the first portion, the dominant orientation of reinforcement fibers 252 may be substantially perpendicular to the stator local helical direction 248. Furthermore, in the second portion, the dominant orientation of reinforcement fibers 252 may be substantially parallel to the stator local helical direction 248 or oriented along a different axis (e.g., stator axis 250).

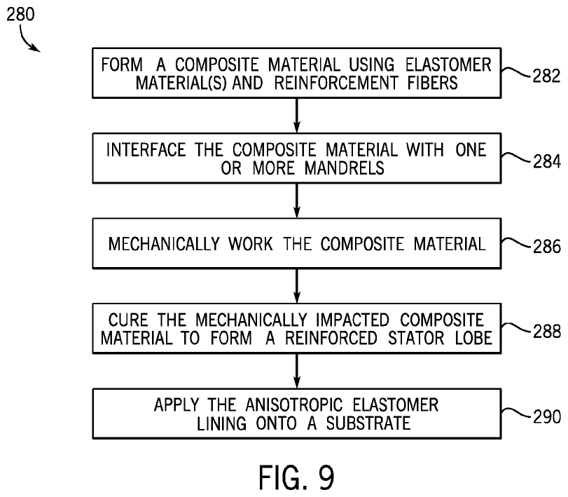

As described herein, the stator 206 and/or the rotor 204 of the power section 18 may be lined with an anisotropic elastomer reinforcement lining 240. FIG. 9 is a flow diagram of a process 280 for applying an anisotropic elastomer reinforcement lining 240 that may be lined, applied, or otherwise provided onto a surface of the stator 206 such as a stator housing, in accordance with embodiments of the present disclosure. The process 280 of applying an anisotropic elastomer reinforcement lining includes using one or more elastomer materials (e.g., elastomer precursor materials) and reinforcement fibers 252 to form a composite material (block 282). In certain embodiments, forming the composite material (block 282) may include adding reinforcement fibers 252 (e.g., a powder including the reinforcement fibers) to an elastomer precursor.

The formed composite material interfaces (block 284) with one or more mandrels, which provide some shape and structure to the formed composite material. For example, interfacing the composite material with the mandrel may facilitate the formation of the lobes and lobe cavities of the anisotropic elastomer reinforcement lining. Interfacing the composite material to one or more mandrels (block 284) may include injecting the composite material into a mold or vessel. In some embodiments, the composite material interfaces with a mandrel via injection molding. A first mandrel may interface with the composite material to facilitate the formation of asymmetric lobes. In some embodiments, the composite material is mechanically worked (e.g., stretched and/or pressed) by the mandrel (block 286) or another component to provide desirable fiber orientation. Mechanically working the composite material within the at least partially uncured elastomer material may change the orientation of the reinforcement fibers 252. In some embodiments, mechanically working the composite material may include removing a first mandrel having a first shape (e.g., asymmetric lobes) from the composite material, and interfacing a second mandrel having a second shape (e.g., symmetric lobes) with the composite material. The insertion of the second mandrel into the partially cured composite material may work the elastomer material to more closely conform to the second shape than the first shape. The orientation of the reinforcement fibers 252 within the partially cured composite material may be changed by interfacing with the second mandrel.

In some embodiments, the composite material interfaces (block 284) with a vessel and shaping components via compression molding. A preform of the composite material (e.g., material strip) may be applied about a mandrel or core for the compression molding. A compression molding system may at least partially compress the preform of the composite material about the mandrel. Compression of the partially cured composite material around the mandrel may mechanically work (block 286) the composite material and affect the orientation of the reinforcement fibers.

The process 280 includes curing (block 288) or setting the composite material. Elastomer materials of the composite material may begin curing soon after formation of the composite material with the reinforcement fibers 252. Heat, pressure, and time facilitate the curing of the composite material, thereby fixing the orientation of the fibers within the anisotropic elastomer reinforcement lining 240. As may be appreciated, various curing schemes may provide different properties to the same composite material. Moreover, the timing of the mechanical work (block 286) of the composite material may affect the degree of change of the orientation of the reinforcement fibers 252. The cured composite material forms the anisotropic elastomer reinforcement lining 240, which may be applied onto a substrate (block 290), for example, an inner surface 272 of a stator housing 238.

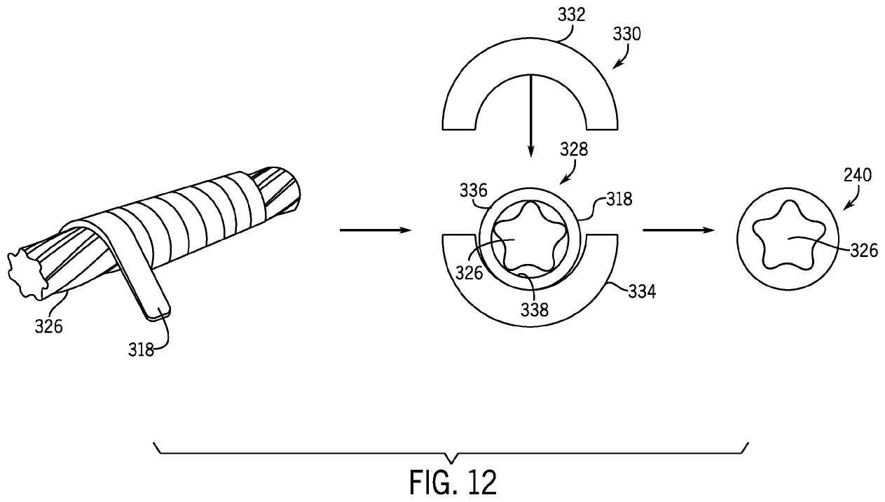

In certain embodiments, working (e.g., mechanically deforming, tensioning, stretching, or combination thereof) the composite material (block 286) may include stretching the composite material subsequent to interfacing the composite material with the mandrel. That is, providing the one or more mandrels to the composite material may include winding the stretched composite material onto the one or more mandrels, which is illustrated and described in more detail with respect to FIG. 12. It is presently recognized that the orientation of the reinforcement fibers 252 may be tuned based on the degree of stretching. For example, stretching the composite material including the reinforcement fibers 252 may generally cause the reinforcement fibers 252 to orient along the direction of stretching. Furthermore, it is presently recognized that, at least in some instances, the reinforcement fibers 252 may relax within the elastomer material 251 when the stretching force is reduced, or generally revert back to a position that is not oriented with the direction of stretching due to the elasticity of the elastomer material 251. Accordingly, it is presently recognized that relaxing the composite material for a predetermined time may also enable tuning of the orientation of the reinforcement fibers 252 within the composite material. For example, after applying a force to stretch the composite material (e.g., for a first time period), a first distribution of the reinforcement fibers 252 may be substantially parallel to each other (i.e., along the direction of the stretching). Furthermore, after a second time period of relaxing, a second distribution of the reinforcement fibers 252 may be substantially parallel to each other. At least in some instances, the second distribution may be less than the first distribution. In this way, an operator desiring a particular degree of orientation may tune the orientation of the reinforcement fibers 252 by adjusting the time period and/or force corresponding to the stretching of the composite material and/or time period corresponding to the relaxing of the composite material.

In certain embodiments, mechanically working the composite material (block 286) may including working the composite material with a first mandrel, such as an anisotropic or asymmetric mandrel. Further, the composite material may be partially cured, such as by providing a suitable amount of heat for a predetermined duration such that a subset of the elastomer material is cured. That is, the composite material may be preheated or partially cured prior to mechanically working the composite material. In general, partially curing the composite material (block 288) may heat the composite material at a relatively lower temperature and/or a relatively shorter time period than suitable to fully cure the composite material. After partially curing the composite material and mechanically working the composite material, the composite material may be fully cured, thereby setting the reinforcement fibers in a cured orientation.

In certain embodiments, the anisotropic elastomer reinforcement lining 240 may include multiple (e.g., 2, 3, 4, 5, or even more) layers. Accordingly, the multiple layers of a composite material may be combined. For example, a first composite material may be formed and stretched along a first direction to orient the reinforcement fibers 252 along the first direction. Furthermore, a second composite material may be formed and stretched along a second direction (e.g., different than the first direction) to orient the reinforcement fibers 252 along the second direction. The first composite material and the second composite material may be combined, thus forming a multilayer anisotropic elastomer reinforcement lining 240, where a first layer corresponds to the first composite material and a second layer corresponds to the second composite material.

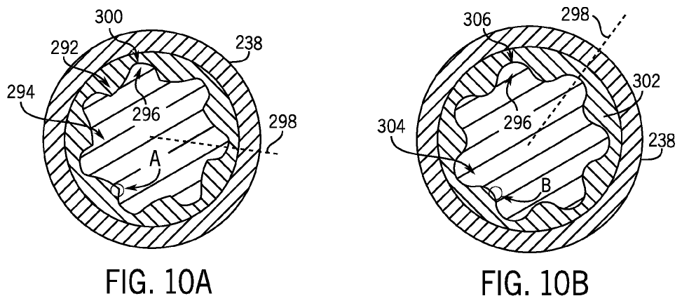

As described above, a composite material may be mechanically pressed using multiple mandrels, thereby causing at least a portion of the reinforcement fibers 252 of the composite material to orient in a direction that is substantially parallel to the surface of the anisotropic elastomer reinforcement lining 240. To illustrate this, FIGS. 10A and 10B show cross-sectional perspective views of a composite material 292 mechanically worked by multiple mandrels. As illustrated in FIG. 10A, the composite material 292 is physically coupled to an asymmetric mandrel 294 within a housing 238. As illustrated, the asymmetric mandrel 294 includes a profile that generally includes protrusions 296 (e.g., lobes) that are asymmetric about a radial axis 298. For example, FIG. 10A illustrates a tip of a lobe 296 at A having an irregular edge or a sharp tip of the profile 300. Accordingly, coupling (e.g., mechanically working) the composite material 292 to the asymmetric mandrel 294 may form a first profile 300 in the composite material 292 that generally matches the protrusions 296 of the asymmetric mandrel 294. After the first profile 300 is formed in the composite material 292, the composite material 292 may be partially cured, as described herein. As illustrated in FIG. 10B, the now partially cured composite material 302 may be physically coupled to a symmetric mandrel 304. The mechanical working of the symmetric mandrel 304 to the partially cured composite material 302 may urge reinforcement fibers 252 of the partially cured composite material 302 to orient substantially parallel to the second profile 306 (e.g., symmetric profile). For example, 10B illustrates a tip of a lobe 296 at B having a regular or smooth tip of the second profile 306. As described herein, partially curing the composite material 292 may decrease the relaxation rate of the composite material 292, thereby increasing the amount of reinforcement fibers 252 that retain orientation with the profile 306.

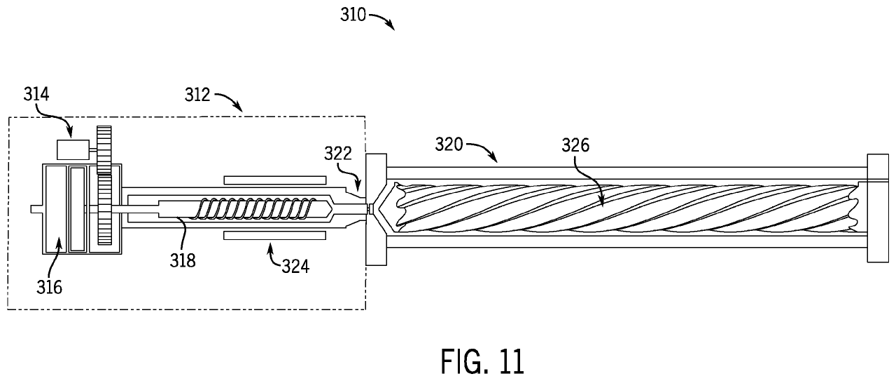

As described above, providing the composite material to one or more mandrels (block 284 of FIG. 9) may include injecting the composite material into a mold (e.g., a vessel) including the mandrels (e.g., performing injection molding). To illustrate this, FIG. 11 is a schematic diagram of an injection molding system 310. The injection molding system 310 includes an injection molding apparatus 312 having a motor 314 that drives a hydraulic cylinder 316 to inject a material 318 (e.g., an elastomer material with reinforcement fibers) into a vessel 320 (e.g., the stator 206) via the nozzle 322. Additionally, the injection molding apparatus 312 includes a heating element 324 that generally increases the temperature of the material 318 before it is injected into the vessel 320. As illustrated, the vessel 320 includes a mandrel 326. As such, the injected material 318 will cool to produce a cooled material having a shape that substantially matches the shape of the mandrel 326.

As described above, providing, at block 284 of FIG. 9, the one or more mandrels to the composite material may include winding the stretched composite material onto the one or more mandrels. To illustrate this, FIG. 12 shows a perspective view of a composite material 318 being wound around a mandrel 326. Winding the composite material 318 about the shaped mandrel 326 may facilitate producing the helical surface 249 into the composite material 318 to form the anisotropic elastomer reinforcement lining 240. Winding the composite material 318 around the mandrel 326 forms a wound intermediate component 328. The wound intermediate component 328 may be provided to a compression molding system 330 including a first mold component 332 (e.g., a removeable mold component, or top plug) and a second mold component 334 (e.g., a fixed mold component, bottom mold). The first mold component 332 and the second mold component 334 may be closed by joining the first mold component 332 with the second mold component 334. The wound intermediate component 328 may then be subsequently compressed (e.g., using a hydraulic press) within the compression molding system 330. Compression of the intermediate component 328 by the mold components 332, 334 may form features on an outer surface 336 that complement features of the mold components 332, 334. The features on the outer surface 336 may facilitate application of the anisotropic elastomer reinforcement lining 240 to a stator housing to form the stator 206. Compression of the intermediate component 328 by the mold components 332, 334 may form features (e.g., lobes, lobe cavities) on the inner surface 338 that complement features of the mandrel 326. Additionally, the compression molding system 330 may be heated, thereby applying suitable pressure and temperature to the composite material 318 to form the anisotropic elastomer reinforcement lining 240 around the mandrel 326. Furthermore, rotation of the mandrel 326 during the compression may mechanically work the composite material and further adjust the orientation of the reinforcement fibers of the anisotropic elastomer reinforcement lining 240. In this way, the anisotropic elastomer reinforcement lining 240 may be formed using a compression molding technique, which may be cheaper and/or quicker to perform as compared to certain injection molding techniques.

Accordingly, the present disclosure relates to techniques for forming an anisotropic elastomer reinforcement lining 240. As described herein, the anisotropic elastomer reinforcement lining 240 generally includes reinforcement fibers 252 (e.g., anisotropic reinforcement fibers 252) that are substantially perpendicular to the helical direction 248. The anisotropic elastomer reinforcement lining may be deposited onto a substrate, such as a stator housing of a drilling motor. The reinforcement fibers of the anisotropic elastomer reinforcement lining may increase the strength and resilience of the stator, such as by increasing the resistance to fatigue chunking and reducing crack propagation through the stator lining. Accordingly, the anisotropic elastomer reinforcement lining may increase the useful life of the stator. By producing an anisotropic elastomer reinforcement lining with the majority of the reinforcement fibers being substantially perpendicular to the helical direction, the anisotropic elastomer reinforcement lining has more resistance to fatigue chunking, higher hardness, and toughness.

Additionally or alternatively, aspects of the present disclosure relate to a composite reinforcement lining for a stator 206. As generally described herein, at least in some instances, a mud motor may operate in an unexpected manner (e.g., operate with reduced efficiency, or otherwise fail to operate) due to abrasion and/or chemical corrosion resulting from downhole conditions. It is presently recognized that it may be advantageous to provide a composite reinforcement lining for a stator that includes certain chemically resistant materials and/or materials having a relatively high dynamic strength.

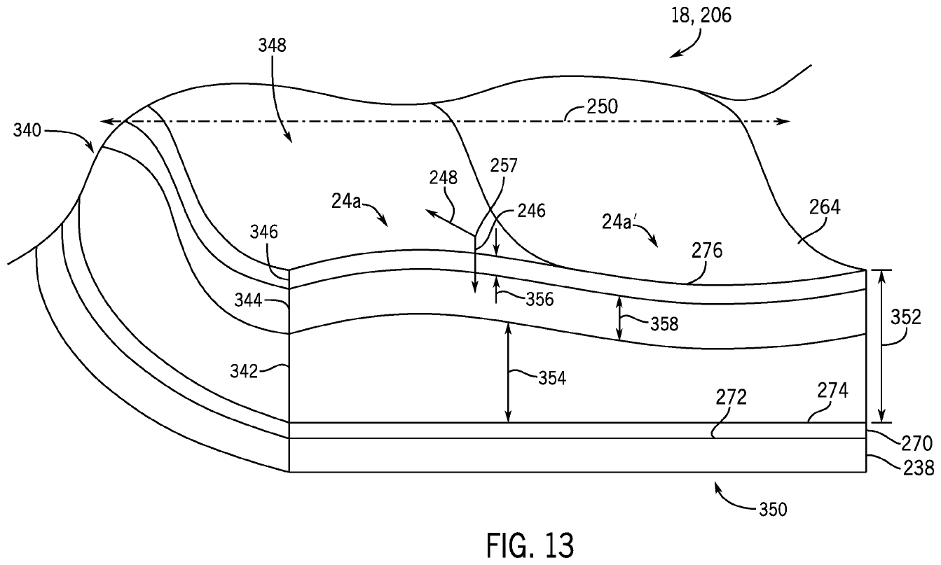

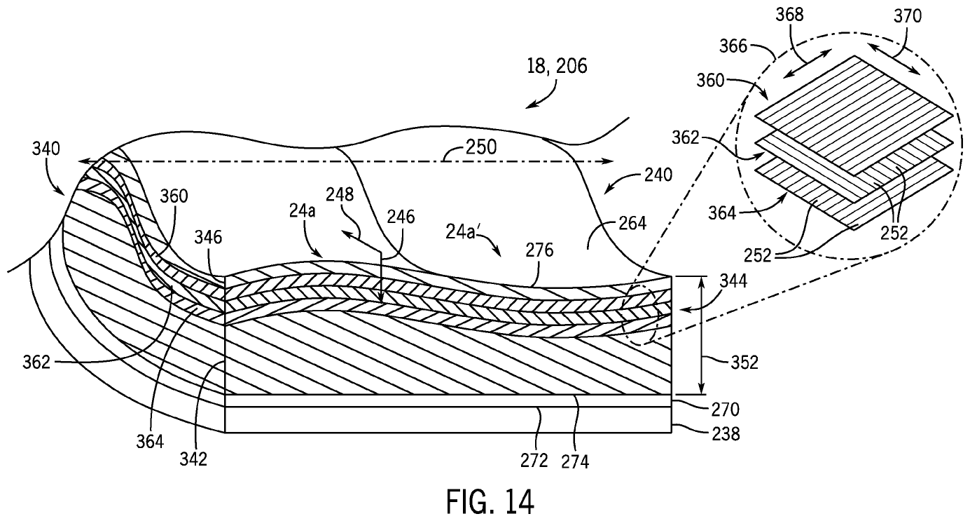

In general, and as described in more detail with respect to FIGS. 13 and 14, the composite reinforcement lining generally includes multiple components. Put differently, the composite reinforcement lining includes multiple sublayers. The materials for each sublayer may be selected to provide a suitable combination of chemical and mechanical properties. For example, the materials of the sublayers may be flexible to withstand deformation. The materials of the sublayers may be bonded to each other. As such, the composite reinforcement lining may enhance stator performance, reliability, durability, chemical resistance, and the like. For example, the sublayers of the composite reinforcement lining may include materials such as elastomers, fabric including rubberized fabric or coated fabric, certain metals (e.g. a foil or net), polymers (e.g. nylon, PTFE, and so forth), resin (e.g. thermoset), or a combination thereof. In a generally similar manner as described above with respect to the anisotropic elastomer reinforcement lining 240, one or more of the sublayers of the composite reinforcement lining are arranged such that a relatively longer dimension of each of the one or more sublayers of the composite reinforcement lining is generally perpendicular to the local helical direction 248.

To illustrate this, FIG. 13 shows a cross-sectional view of a stator 206 having a composite reinforcement lining 340. As illustrated, the composite reinforcement lining 340 includes an outer layer 342 (e.g., a first elastomer layer), an intervening layer 344 (e.g., a reinforcement layer), and an inner layer 346 (e.g., a second elastomer layer). It should be noted though that although only three layers (e.g., the outer layer 342, the intervening layer 344, and the inner layer 346) are shown, the composite reinforcement lining 340 may include any suitable number of layers (e.g., 4, 5, 6, 7, 8, or greater than 8).

As illustrated, the intervening layer 344 is disposed between the outer layer 342 and the inner layer 346. More specifically, the composite reinforcement lining 340 extends from an interior 348 of the stator 206 to an exterior 350 of the stator 206, such that the composite reinforcement lining 340 includes a thickness 352. The intervening layer 344 is disposed at a first distance 354 from the interior surface 276. The intervening layer 344 is disposed at a second distance 356 from the outer surface 274 (e.g., corresponding to the thickness of the outer layer 342). Accordingly, the intervening layer 344 has a thickness 358. It should be noted that, in the illustrated embodiment, the thickness of the outer layer 342 is substantially equal to the first distance 354 and the thickness of the inner layer 346 is substantially equal to the second distance 356. However, it should be appreciated that in embodiments where the composite reinforcement lining 340 includes more than four layers, the first distance 354 and/or the second distance 356 may be approximately equal to a sum of multiple layers (e.g. the sum of the thicknesses of a first inner layer and a second inner layer disposed above the intervening layer 344 (e.g., in a direction towards the exterior 350).

As illustrated, the first distance 354 is greater than the second distance 356. Put different, the intervening layer 344 is generally closer to the interior 348 of the stator 206 than to an exterior 350 of the stator 206. In some embodiments, the second distance 356 is such that the intervening layer 344 is provided close enough to the interior stator surface 276 to reduce a likelihood of crack propagation. For example, the intervening layer 344 may be arranged in the stator 206 as the dashed outline illustrated in FIG. 5, wherein the intervening layer 344 is spaced the second distance 356 from the interior surface 276 of the stator 206. It is presently recognized that a crack propagates at or near the interior surface 276 of the stator, such as a position at 50% or less, 40% or less, 30% or less, 20% or less, 10% of less, 5% or less, or 1% or less, of the thickness 352 from the interior surface 276. Accordingly, a ratio of the first distance 354 to the stator thickness 352 may be between 1:3 to 1:100 (1%-33%) of the thickness 352. For example, the ratio of the first distance 354 to the stator thickness 352 may be 1:100 or less, 1:50 or less, 1:20 or less, 1:10 or less, 1:5 or less, 1:3 or less, or 1:4 or less.

In general, the composite reinforcement lining 340 may be physically coupled to the stator housing 238 in a generally similar manner as described herein with respect to the anisotropic elastomer reinforcement lining 240. For example, in some embodiments, the composite reinforcement lining 340 may be physically coupled to the stator housing 238 via an adhesion layer 270. Furthermore, the composite reinforcement lining 340 may generally reduce the likelihood of chunking resulting from a crack forming at the contact location 257 and propagating along the helical direction 248. To do so, the intervening layer 344 may include one or more reinforcement fibers 252 that are substantially perpendicular to the helical direction 248.

In one embodiment, the outer layer 342 and the inner layer 346 may be formed of a generally flexible material, such as an elastomer, and the intervening layer 344 may be a relatively more rigid layer as compared to the elastomer. For example, the intervening layer 344 may include, or otherwise be formed of, a fabric, metal, polymer, resin, or a combination thereof, while the outer layer 342 and the inner layer 346 may include an elastomer. In this way, the inner layer 346 may continue to seal the lobes 205 of the rotor 204, while the intervening layer 344 provides chemical and/or mechanical resistance for the outer layer 342, thereby reducing a likelihood of fatigue chunking or other types of abrasion or corrosion that may reduce the longevity of the inner layer 346.

In some embodiments, the intervening layer 344 may include one or more reinforcement fibers 252. To illustrate this, FIG. 14 shows a cross-sectional view of a portion of the power section 18 including an intervening layer 344 disposed between an outer layer 342 and an inner layer 346. In a generally similar manner as described herein with respect to the anisotropic elastomer reinforcement lining 240 of FIG. 8, the intervening layer 344 includes reinforcement fibers 252 with an orientation substantially perpendicular to the local helical direction 248.

As illustrated, the intervening layer 344 include a first layer 360, a second layer 362, and a third layer 364. In some embodiments, each of the first layer 360, the second layer 362, and the third layer 364 may include reinforcement fibers 252. This is generally illustrated in the inset 366 of the intervening layer 344. As illustrated, the reinforcement fibers 252 are each arrange along a longitudinal axis 368 and a transversal axis 370, which generally corresponds to the dimensions of the intervening layer 344. It is appreciated that sets of fibers or a sublayer within the intervening layer may have other angular offsets relative to other sets of fibers or sublayers. For example, the longitudinal axis 368 is substantially perpendicular to the helical direction 248. As such, at least a portion of the reinforcement fibers 252 (i.e., the reinforcement fibers oriented as shown in the first layer 360 and the third layer 364) may mitigate crack propagation in a direction (e.g., helical direction 248) across the reinforcement fibers. In any case, the orientation of the reinforcement fibers 252 in the first layer 360, the second layer 362, and the third layer 364 may provide the composite reinforcement lining 340 with improved mechanical resistance as compared to conventional elastomers linings. Further, providing the intervening layer 344 between two elastomer layers (e.g., the outer layer 342 and the inner layer 346) may enable the composite reinforcement lining 340 to be produced with compression molding. It should be noted that while only three layers are shown, the intervening layer 344 may include any suitable number of layers, such as four or fewer, five or fewer, six or fewer, seven or fewer, ten or fewer, fifty or fewer, or more than fifty. Additionally, the angular offset between sublayers of the intervening layer may be between −45° to 45°. In some embodiments, the intervening layer may be a multi-layer fabric, mesh, or woven structure, such as an aramid fiber fabric, stainless steel fiber fabric, nylon fiber fabric, and other fabrics having a suitable strength.

As illustrated, the reinforcement fibers 252 are dispersed along the thickness 358 within the intervening layer 344. In some embodiments, the thickness 352 may be between 0.5 cm and 10 cm. In some embodiments, the thickness 352 of the anisotropic composite reinforcement lining 340 varies along the stator axis 250 and with the circumferential position of the stator 206 because of the helical stator lobes (e.g., lobe 24a) and lobe cavities (e.g., lobe cavity 24a′) described above.

The dominant orientation of the reinforcement fibers 252 may be substantially perpendicular to the local helical direction 248 at the crack nucleation site 257. As discussed above, the local helical direction 248 corresponds to a direction along the stator surface 276 in which a crack 259 may propagate. Additionally, the crack direction 246 corresponds to a direction perpendicular to the local helical direction at the crack nucleation site 257. Together, the local helical direction 248 and the crack direction 246 form the crack plane 262 at the crack nucleation site 257. As such, the reinforcement fibers 252 oriented to be substantially perpendicular to the crack plane 262 may reduce, prevent, or block the crack 259 from propagating further, thereby improving the longevity of the stator. Further, the fiber orientations 256 have angular offsets 263 with the crack plane 262. In certain embodiments, an angular offset 263 between the crack plane 262 and the fiber orientation 256 may be between −45°to 45°. In certain embodiments, the angular offset 263 may be between −35° to 35°, −25° to 25°, −15° to 15°, or −5° to 5°.

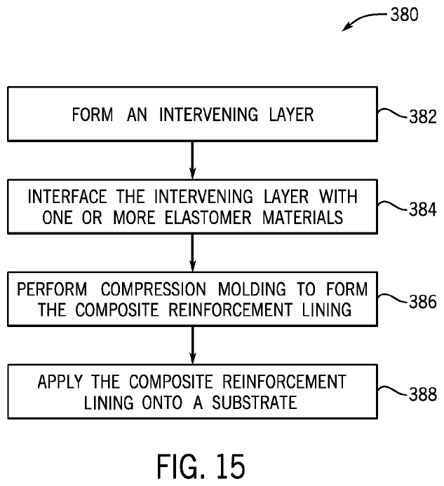

FIG. 15 is a flow diagram of a process 380 for generating a composite reinforcement lining 340 that may be lined, applied, or otherwise provided onto a surface of a stator 206, in accordance with embodiments of the present disclosure. A first step of the process 380 is to form an intervening layer (e.g., the intervening layer 344) using one or more reinforcement materials (block 382). Next, one interfaces the intervening layer with one or more elastomers (block 384). Interfacing the intervening layer with the one or more elastomers may include stacking, wrapping, winding, collapsing, or expanding the intervening layers on the one or more elastomers that will form the interior or the exterior of the composite reinforcement lining. In some embodiments, the intervening layer is stacked, collapsed, or wrapped around the one or more elastomers proximate to a mandrel. Additionally, or in the alternative, the intervening layer is stacked or expanded within the one or more elastomers forming an exterior of the composite reinforcement lining. After positioning the intervening layer with the one or more elastomers, one performs compression molding (block 386) with the intervening layer 344 and the one or more elastomer linings to form a composite reinforcement lining 340 (block 386). The one or more elastomers of the composite reinforcement lining 340 may be cured during or after the compression molding. The composite reinforcement lining 340 is applied onto a substrate (block 388).

At least in some instances, certain approaches to reinforce a stator elastomer lining may be limited by the viscosity requirement for injection molding process. Thus, it is presently recognized that compression molding techniques may be advantageous for forming a composite reinforcement lining 340, which may provide improved mechanical and thermal resistance to the stator 206 although the viscosity of the materials used may be slightly higher than desirable relative to injection molding processes. Put differently, manufacturing a stator with the disclosed composite through compression molding will mitigate the limitation on elastomer compound viscosity and allow more approaches feasible for reinforcing elastomer materials. Further still, the implementation of the reinforcing layer (i.e., the intervening layer 344) in the compression molding process will further simplify manufacturing process and elastomer formulations. It is also presently recognized that pre-placing fabric through weaving or a fabric mat in the mold before running rubber injection can result in non-uniform distribution or undesired orientation of reinforcing fibers.

Forming the reinforcement lining using the one or more reinforcement materials may generally involve flattening or otherwise forming a layer having a length to coat a mold. In general, the intervening layer 344 may be formed of materials having a relatively stronger mechanical resistance and/or relatively higher temperature resistance than the elastomer materials. For example, the intervening layer 344 may include fabrics such as aramids, stainless steel fabrics, and the other materials having a mechanical resistance (e.g., a hardness) that is greater than the materials of the outer layer 342 and/or of the inner layer 346.

Forming the intervening layer 344 may generally involve stretching or winding one or more elastomer materials. In general, the elastomer materials for the composite reinforcement lining 340 may include at least one of acrylonitrile butadiene, carboxylated acrylonitrile butadiene, hydrogenated acrylonitrile butadiene, carboxylated hydrogenated acrylonitrile butadiene, ethylene propylene, ethylene propylene diene, tetrafluoroethylene and propylene copolymer, a fluorocarbon, a perfluoroelastomer, or other suitable elastomers as described with respect to the anisotropic elastomer reinforcement lining 240. In general, the intervening layer 344 may be placed in a suitable position within the elastomer materials such that the intervening layer 344 is at a suitable distance (i.e., the second distance 356 as described above with respect to FIG. 13) from the interior surface 276 and the outer surface 274 to ensure sufficient squeeze between the lobes of the stator 206 and the rotor 204.

Performing compression molding using the intervening layer 344 may generally include physical coupling the intervening layer 344 with the inner layer 346 and/or the outer layer 342 to form a pre-form. As referred to herein, the pre-form is generally the pre-cured composite elastomer reinforcement lining 340. That is, the pre-cured composite elastomer reinforcement lining 340 may include the multiple layers as described with respect to FIGS. 13 and 14 before being fitted to the mold for curing to form the final stator geometry. In general, this may involve applying one or more elastomer materials to the mold to form a first layer (e.g., the outer layer 342 described with respect to FIG. 13). For example, this may include, stretching and winding the elastomer around the mandrel to form the first layer. Furthermore, the material of the intervening layer may be provided around the first layer, thereby forming the intervening layer 344. At least in some instances, an elastomer may be applied to the intervening layer 344 prior to providing the other elastomer materials for the outer layer 342 and the inner layer 346, which may improve the binding of the intervening layer 344 and the elastomer materials that ultimately form the composite reinforcement lining 340. Furthermore, performing compressing molding may include providing the pre-form to a mold (e.g., a vessel) and compressing the mold under a relatively higher pressure (e.g., greater than 100 psi) and temperature (e.g., greater than 100° C., greater than 150° C., greater than 200° C.) for a predetermined time period (e.g., 1 minute, 3 minutes, 5 minutes, 10 minutes, or greater than 10 minutes).

In some embodiments, multiple intervening layers (e.g., reinforcement linings) may be formed around the inner layer 346. It should be noted that overlapping the intervening layer (i.e., that is wound around the first layer) along the parting line from compression molding may increase the likelihood of full coverage of the intervening layer in the composite elastomer reinforcement lining 340. After applying the intervening layer, the second layer (e.g., outer layer 342) of an elastomer material may be applied to the intervening layer in a generally similar manner as described with respect to applying the first layer. The composite material (e.g., the mold coupled to the first layer, the first layer coupled to the intervening layer, and the intervening layer coupled to the second layer) may be compressed as described above. Applying the composite reinforcement lining onto a substrate (block 388), such as a stator housing, may be performed in a generally similar manner as described with respect to FIG. 12.

Accordingly, an additional aspect of the present disclosure relates to a composite reinforcement lining 340 that generally includes multiple layers (e.g., sublayers). More specifically, the composite reinforcement lining 340 may include an intervening layer 344 (e.g., a reinforcement lining) that is disposed between the stator housing 238 of the stator 206 and an elastomer layer (e.g., the second layer 346 as described with respect to FIG. 13). The intervening layer 344 may include materials that have a relatively higher the mechanical resistance and/or thermal resistance than the second layer 346 and/or the first layer 342, in such embodiments where the first layer 342 is included. In any case, the composite reinforcement lining 340 may be formed using a pre-form including the materials of the reinforcement lining and one or more elastomer materials.

The specific embodiments described herein have been illustrated by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for (perform)ing (a function) . . . ” or “step for (perform)ing (a function) . . . ”, it is intended that such elements are to be interpreted under 35 U.S.C. 112(f). However, for any claims containing elements designated in any other manner, it is intended that such elements are not to be interpreted under 35 U.S.C. 112(f).

1-7. (canceled)

8. A system, comprising:
a stator housing of a mud motor; and
a composite elastomer lining comprising:
a first elastomer layer coupled to an inner surface of the stator housing;
a second elastomer layer configured to receive a rotor of the mud motor; and
an intervening layer disposed between the first elastomer layer and the second elastomer layer, wherein the intervening layer comprises a plurality of reinforcement fibers,
wherein the plurality of reinforcement fibers comprises a first set of fibers and a second set of fibers, wherein the first set of fibers is arranged in a first direction, and the second set of fibers is arranged in a second direction with an angular offset relative to the first direction.

9. The system of claim 8, wherein a thickness of the second elastomer is less than ⅓ of a total thickness of the composite elastomer lining.

10. The system of claim 8, wherein a thickness of the second elastomer is less than 1/10 of a total thickness of the composite elastomer lining.

11. The system of claim 8, wherein the composite elastomer lining comprises a compression molding preform component.

12. (canceled)

13. The system of claim 8, wherein the first direction is substantially perpendicular to a local helical direction of the mud motor.

14. The system of claim 8, where in the first layer comprises acrylonitrile butadiene, carboxylated acrylonitrile butadiene, hydrogenated acrylonitrile butadiene, carboxylated hydrogenated acrylonitrile butadiene, ethylene propylene, ethylene propylene diene, tetrafluoroethylene and propylene copolymer, a fluorocarbon, a perfluoroelastomer, or a combination thereof.

15. The system of claim 8, wherein the intervening layer comprises an aramid fiber fabric, a stainless steel fiber fabric, or a nylon fiber fabric.

16-20. (canceled)
